(19) United States
(12) Patent Application Publication
(10) Pub. No.: US 2019/0061885 A1
(43) Pub. Date: Feb. 28, 2019

(54) Modular Floating Microgrid Energy Platforms

(71) Applicant: Power Docks LLC, Fall River, MA (US)

(72) Inventors: Anthony BARO, Bristol, RI (US); Chris Fagan, Middletown, RI (US)

(21) Appl. No.: 16/103,642

(22) Filed: Aug. 14, 2018

Related U.S. Application Data
(63) Continuation-in-part of application No. 15/459,500, filed on Mar. 15, 2017, now abandoned.

(51) Int. Cl. B63B 35/44; H02S 10/10; H02S 10/20; H02S 10/40

(52) U.S. Cl. CPC B63B 35/44; H02S 10/10; B60L 11/1824; H02S 10/40; B63B 2035/4433; H02S 10/20

(57) ABSTRACT

A floatable energy platform including a buoyant structure capable of floating on water, at least one source of renewable energy carried by the structure, and power transfer equipment capable of recharging at least one type of electric-powered vehicle. Modular platforms can be readily transported and interconnected to provide different energy generation and storage capabilities.

### CROSS-REFERENCE TO RELATED APPLICATION

This application is a continuation-in-part application of U.S. patent application Ser. No. 15/459,500 filed 15 Mar. 2017 and claims priority to U.S. Provisional Applications No. 62/308,554 filed 15 Mar. 2016, No. 62/343,109 filed 30 May 2016, No. 62/343,270 filed 31 May 2016, and No. 62/328,092 filed 31 May 2016. The entire contents of each of the above-mentioned applications are incorporated herein by reference.

### FIELD OF THE INVENTION

This invention relates to micro-grid systems for generating and supplying power, particularly to floatable renewable energy platforms that are deployable where needed.

### BACKGROUND OF THE INVENTION

There has been a long-felt need for obtaining power, especially electrical energy, in and near the ocean and other aquatic environments. U.S. Pat. No. 5,512,787 by Dederick discloses various combinations of solar panels, wind turbines and wave action generators on bridges, barges, and other fixed and floating structures. A system for generating electrical power for a port is described in US Patent Application Pub. No. 2012/0200156 by Weller. A rapid response portable hybrid emergency energy generator is presented in U.S. Pat. No. 7,821,147 by Du Bois.

Floating power generation devices and systems are described in a number of documents including U.S. Pat. No. 7,696,633 by Zajehowski et al. and in US Patent Application Pub. Nos. 2012/0242275A1 and 2016/0059938A1 by Kokusho and Momayez et al., respectively. Life-saving equipment with a solar cell, an energy storage device, and a signal generator to request help are shown in US Patent Application Pub. No. 2008/0214074A1 by Fan.

Other floating structures to capture and convert wind energy are discussed in U.S. Pat. No. 8,664,795 by Borden et al. Solar equipment for lifesaving in water is described by Fan in US Patent Publication No. 2008/0214074. Propulsion of craft utilizing wind turbines is described by Snow in US Patent Publication No. 2010/0317243, for example.

There is an increasing need for operating unmanned underwater vehicles (UUV) including autonomous underwater vehicles (AUV), as well as unmanned aerial vehicles (UAV) including drones to study both natural and man-made phenomena. Both UUV and UAV require periodic charging of their power supplies, typically via rechargeable batteries. A need for multiple “nodes” for communication is described by Farr et al. in U.S. Pat. No. 7,953,326 and US Patent Publication No. 2016/0127042, for example,

It is therefore desirable to have improved deployable platforms that can be positioned and configured as needed to provide multiple capabilities.

### SUMMARY OF THE INVENTION

An object of the present invention is to provide autonomous powered platforms that are readily transported and deployed in aquatic and/or remote environments.

Another object of the present invention is to enable docking and recharging by one or more of surface vessels, underwater vehicles, and/or aerial vehicles.

This invention features a modular energy platform including a buoyant structure capable of floating on water, having at least one source of renewable energy carried by the structure, and power transfer equipment capable of recharging at least one type of electric-powered vehicle. The source includes at least one panel of photovoltaic cells that are at least one of (i) flexible or (ii) configured to withstand the weight of at least one human

In some embodiments, the platform includes at least one inflatable chamber. In certain embodiments, the platform further includes at least one of; (1) integrated communications equipment capable of data transfer to remote command and control centers; (2) integrated connectors and wireless charging devices; (3) integration of vertical wind power, wave energy, tidal power, and/or thermal power generation sources and devices; (4) integrated energy storage, battery charging management systems, power conversion and inverters; (5) integrated water sensing devices to measure a selected parameter including at least one of temperature, salinity, density and turbidity; (6) integrated autonomous navigation system and capabilities; (7) integrated electric marine propulsion systems; (8) integrated water desalination systems; (9) integrated water remediation systems; (10) integrated sustainable materials; and/or (11) integrated data and communication equipment for wireless signal services.

This invention further features a portable platform to generate and distribute renewable energy, including a structure made of flexible inflatable material such as a water-resistant treated fabric designed to withstand forces of nature and marine environmental conditions, the structure having an upper surface and a lower surface with foldable features incorporated into the material of the structure to enable the structure to transition from a collapsed condition to an expanded condition when the structure is inflated with air, and at least one source of renewable energy.

In certain embodiments, the portable platform further includes at least one of: (a) integrated power distribution receptacle outlet; (b) integrated compressed air inflatable device capable of being activated on request; (c) integrated PV attachment features to outside surfaces; (d) integrated antifouling submerged surface; and/or (e) integrated handling features including at least one of cleats, handles, and eyes for lift tackle. In some embodiments, the portable platform includes at least one of: (i) integrated flexible solar panels; (ii) energy storage; (iii) power distribution marine outlet; and/or (iv) e antenna for extended telecommunication signal interface.

This invention also features an assembly, and a method of transporting and deploying same, of at least one primary platform having at least energy storage capabilities and at least one secondary platform having at least renewable energy generation capabilities and electrically connected to the primary platform. The at least one secondary platform defines at least one chamber that is inflatable with air to transition from a collapsed condition to an expanded condition. In some embodiments, the primary platform is formed from at least two rigid pieces that establish at least one storage compartment for energy storage devices, and each of the secondary platforms is directly connected electrically to the primary platform.

### BRIEF DESCRIPTION OF THE DRAWINGS

In what follows, preferred embodiments of the invention are explained in more detail with reference to the drawings, in which:

FIGS. 1A and 1B are simplified schematic elevation and top plan views, respectively, of a buoyant floating energy platform according to the present invention carrying flexible solar panels;

FIGS. 2A and 2B are schematic elevation and top plan views, respectively, of an alternative floating platform according to the present invention carrying solar panels;

FIGS. 3A and 3B are schematic elevation and top plan views, respectively, of an alternative floating platform according to the present invention secured to a mooring ball and carrying solar panels;

FIG. 4 is a schematic top plan view of an alternative floating platform according to the present invention carrying solar panels, a drone landing pad with wireless recharging equipment, and a power pedestal;

FIG. 5 is a schematic perspective view of an alternative floating platform according to the present invention having an underwater docking station and carrying solar panels;

FIGS. 6A and 6B are schematic upper and side perspective views, respectively, of an alternative floating platform according to the present invention for recharging aerial and underwater vehicles;

FIG. 7A is a schematic perspective view of an alternative floatable primary microgrid platform according to the present invention capable of generating and storing energy;

FIG. 7B is a schematic cross-sectional view along lines 7B-7B in FIG. 7A;

FIG. 8A is a schematic perspective view of an alternative inflatable secondary platform according to the present invention carrying photovoltaic cells;

FIG. 8B is a schematic cross-sectional view along lines 8B-8B in FIG. 8A;

FIG. 8C is a schematic side view of a shipping assembly according to the present invention with an inverted primary platform over, a plurality of secondary platforms in a collapsed condition;

FIG. 9 is a schematic perspective view of a linear arrangement of one primary platform linked to three secondary platforms;

FIG. 10 is a schematic perspective view of a square arrangement of one primary platform linked to three secondary platforms;

FIG. 11 is a schematic perspective view of a surround arrangement of one primary platform surrounded by eight secondary platforms;

FIG. 12A is a schematic perspective view of an alternative molded floatable platform according to the present invention;

FIG. 12B is a cross-sectional view of the platform of FIG. 12A;

FIG. 13A is a schematic perspective view of an alternative floating buoy-type platform according to the present invention;

FIG. 13B is a cross-sectional view of the buoy platform of FIG. 13A;

FIG. 14A is a schematic perspective view of an alternative floating dock-type platform according to the present invention; and

FIG.14B is a schematic partial cross-sectional view of FIG. 14A.

### DETAILED DESCRIPTION OF THE PRESENTLY PREFERRED EMBODIMENTS

This invention may be accomplished by a floatable energy platform including a buoyant structure capable of floating on water, at least one source of renewable energy carried by the structure, and power transfer equipment capable of recharging at least one type of electric-powered vehicle. Certain illustrative combinations of components and capabilities are described herein, with other combinations occurring to those skilled in the relevant technical arts after reviewing this disclosure.

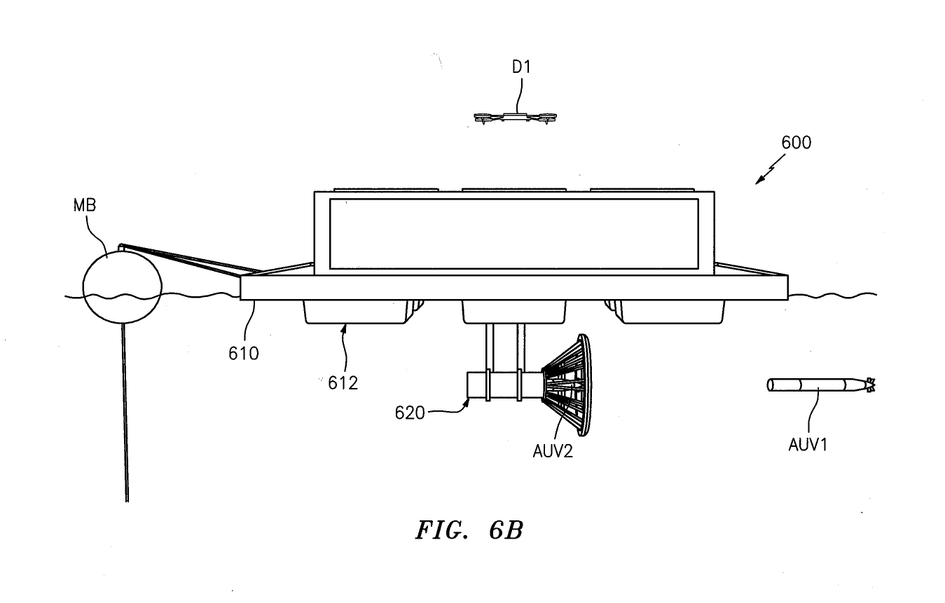

As described in more detail below in relation to FIGS. 7A-11, a currently preferred unit is designed to be a modular quick-deploy, micro-grid solution either on the water, typically as a floating platform, or on the land to collect renewable energy, store energy and ultimately redistribute electric energy. In some constructions, the system is comprised of two members: (i) a primary rigid-bottom, typically square-shaped “Mother” unit; and (ii) multiple inflatable secondary “Cell” units. The “Mother” unit would contain the batteries (AGM, Lithium or other), an inverter and various power ports. Each of the “Cell” units would be made as an inflatable structure with flexible solar panels on the top canopy. A single “Mother” unit could support multiple “Cell” units in order to generate significant power quantities. The modular nature of the design would allow for various configurations based on environmental conditions. The overall system could be deflated and stacked for optimal shipping sizes with-in a standard container. Overall the present Inflatable Micro-Grid System provides users with a quick deploy solution to off-grid power generation and distribution. Specifically, it would be an asset in emergency conditions, such has hurricane storm or earthquake relief.

As further described below, another preferred unit is a Micro-Grid Dock that is designed to bring energy production directly into the hard infrastructure of marinas, ports and related aquatic environments. Specifically, the docks collect renewable energy, store that energy and then ultimately redistribute the electric energy back to the user. This can happen directly through a traditional marine power pedestal or through net metering back into the grid. In one construction, the micro-grid docks contain a walkable solar surface, such as available from Solbian of Avigliana, Italy or Solara GmbH of Hamburg, Germany, with batteries (AGM, Lithium or other) and inverter built to be concealed below the deck. The structure of the dock itself can be constructed from wood timber, concrete, metal or composite materials. Overall this “Micro-Grid Dock” will allow electric propulsion and traditional marine vessels to recharge without the need of a larger power grid,

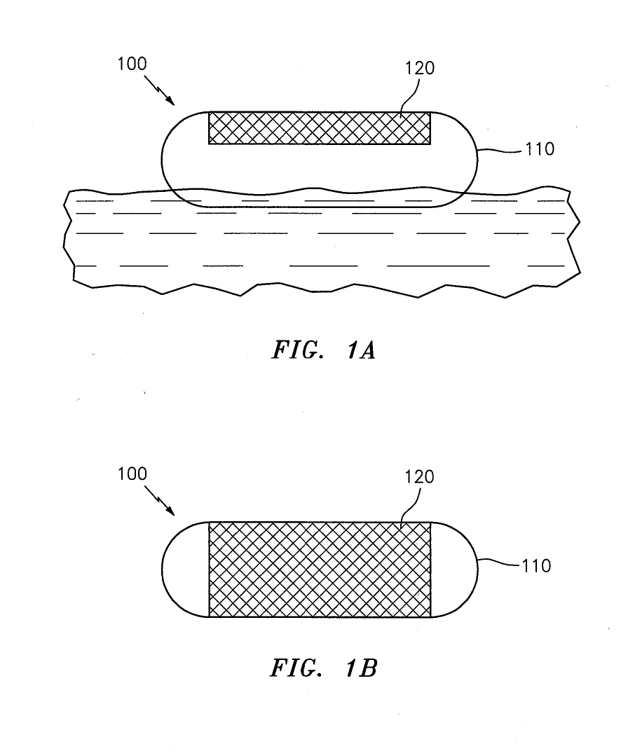

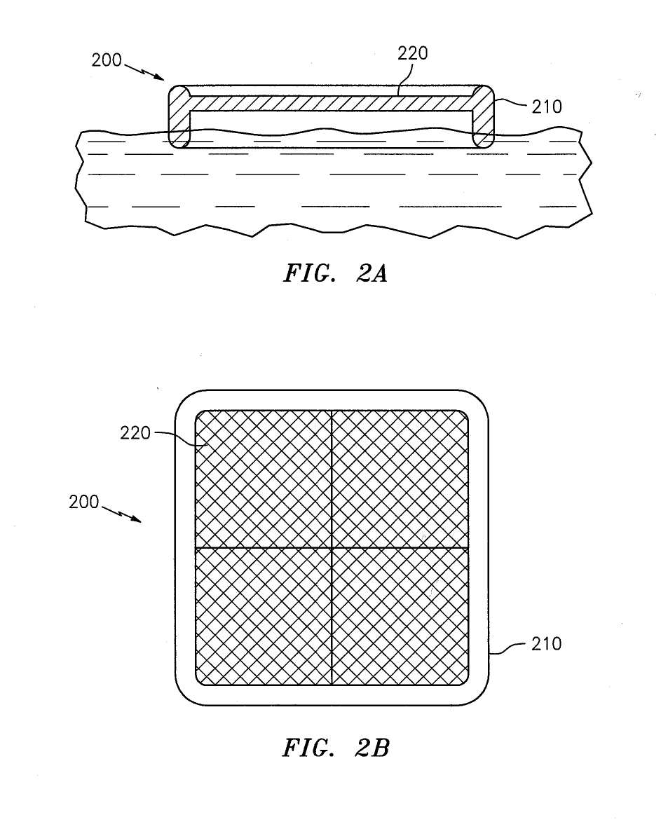

A simplified buoyant floating energy platform 100 according to the present invention, FIGS. 1A and 1B, includes inflatable or molded, generally cylindrical structure 110 carrying flexible solar panels 120.

An alternative floating platform 200 according to the present invention, FIGS, 2A and 2B, includes inflatable or molded, polygonal structure 210 carrying solar panels 220.

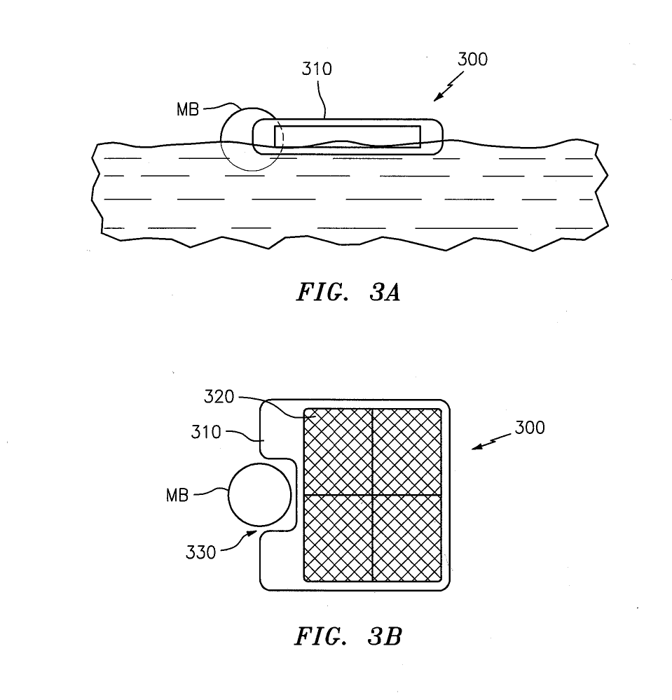

An alternative floating platform 300 according to the present invention, FIGS. 3A and 3B, has a structure 310 defining a recess 330 which is at least as large as a selected mooring buoy MB, also referred to as a mooring ball MB. The structure 310 is secured to the mooring buoy MB after a desired location has been reached. Structure 310 carries at least solar panels 320.

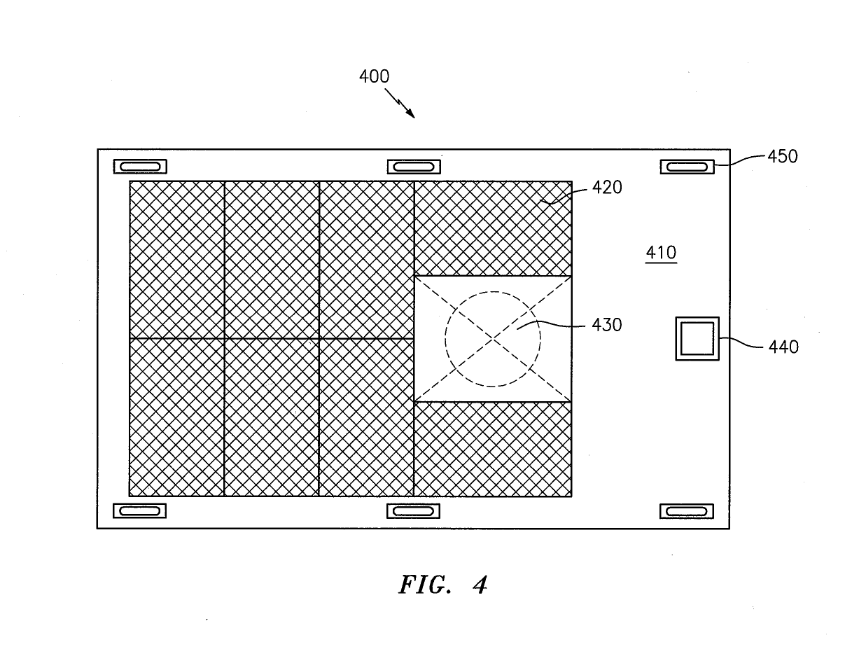

FIG. 4 is a schematic view of an alternative floating platform 410 according to the present invention including a buoyant structure 410 carrying solar panels 420, a drone landing pad 430 with wireless recharging equipment, and a power pedestal 440. Additional hardware such as cleats 450 facilitates mooring of surface vessels to the platform 410.

Suitable sources for flexible solar panels include ApolloFLEX™ marine flexible solar panels available from Stored Energy Products Inc. of Lake Worth, Fla. and Solar Flex™ panels available from Carmanah Technologies Corp. With suitable structural support added beneath the solar panels, such as a recessed frame of decking material, some panels are capable of being tread upon by one or more humans. Suitable power pedestals include HYPOWER™ pedestals from Hypower, a division of HydroHoist Marine Group. Suitable wireless recharging equipment include WiBotic™ wireless power solutions from WiBotic of Seattle, Wash.

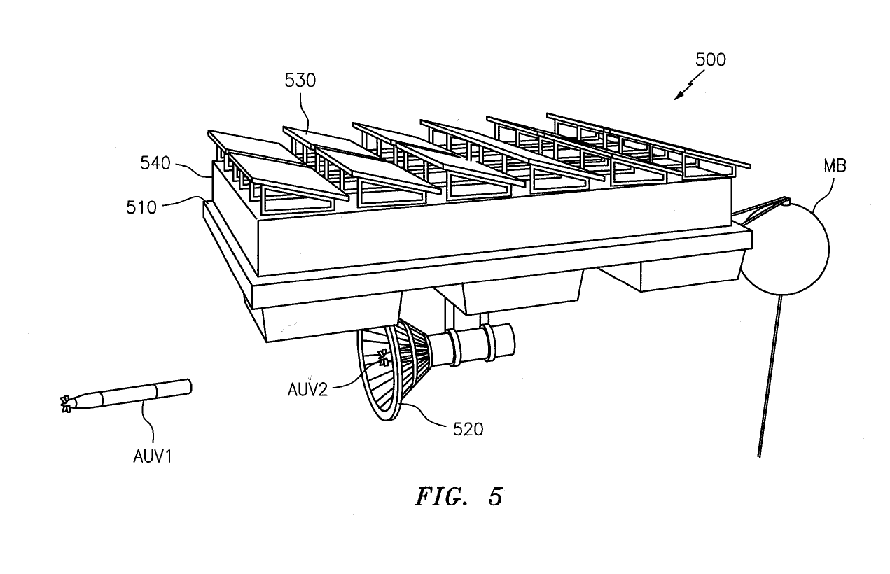

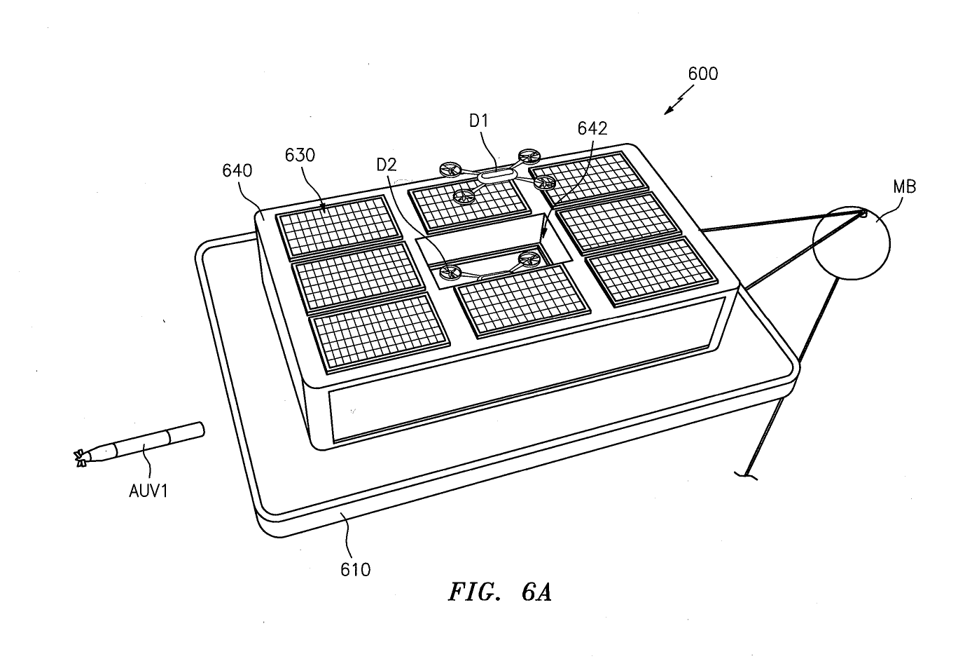

FIG. 5 is a schematic view of an alternative floating platform 500 according to the present invention including a float structure 510 secured to mooring ball MB. A lower surface of structure 510 carries an underwater docking station 520 and an upper surface of structure 510 carries an array of solar panels 530, which are mounted on an energy storage platform 540 in this construction. The energy storage platform 540 holds energy storage components such as marine batteries. AUV1 is shown approaching the docking station 520, which is currently holding AUV2 for recharging and transfer of information.

An alternative floating platform 600 according to the present invention, FIGS, 6A and 6B, includes a structure 610 secured to mooring ball MB and having floats 612 containing air and/or a buoyant material such as rigid foam. Platform 600 includes equipment for recharging aerial and underwater vehicles such as drone D1, shown airborne, docked drone D2, and underwater AUV1 and AUV2. Solar panels 630 are carried by energy storage structure 640, which also defines a recess 642 which serves as a landing pad and recharging area for the drones. In one construction, structure 610 and/structure 640 also include a hanger or other storage facility for drones. The lower surface of structure 610 also carries an underwater docking station 620, shown cradling and recharging the AUV2.

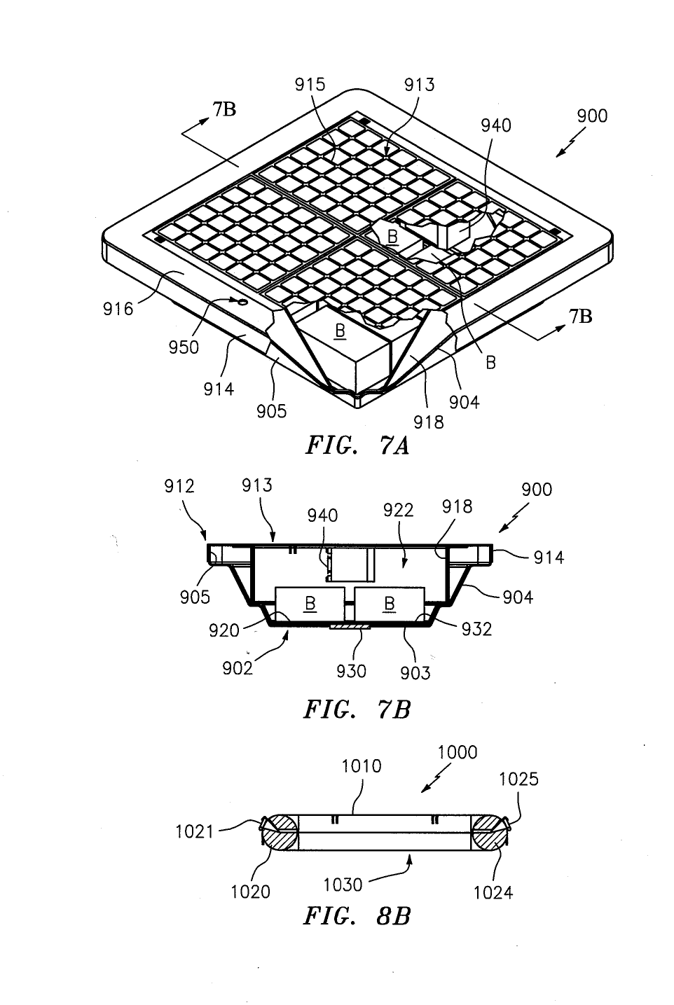

FIGS. 7A-7B illustrate an alternative floatable primary microgrid platform 900 according to the present invention capable of generating and storing energy. FIGS. 8A-8B show an alternative inflatable secondary platform 1000 according to the present invention carrying photovoltaic cells and electrically connectable to the primary platform 900 to transfer power for immediate use and/or storage and subsequent use as needed. These platforms 900 and 1000 can be assembled in different configurations to serve as a modular quick-deploy, micro-grid solution on either the water, typically as a floating platform, or on the land to collect renewable energy, store energy and ultimately redistribute electric energy. In some constructions, the system is an assembly comprised of two members: (1) a primary rigid-bottom, typically square-shaped “Mother” unit 900; and (ii) multiple inflatable secondary “Cell” units 1000. As shown in FIGS. 7A-7B, the “Mother” unit 900 contains the batteries “B” (AGM, Lithium or other) in storage compartment 922, an inverter 940, and various power ports 950.

In one construction, each “Cell” unit 1000, FIGS. 8A-8B, is made as an inflatable structure with flexible photovoltaic panels 1010 on the top canopy. A single “Mother” unit could support multiple “Cell” units in order to generate significant power quantities. The modular nature of the design would allow for various configurations based on environmental conditions. The overall system could be deflated and stacked for optimal shipping sizes with-in a standard container. Overall the present Inflatable Micro-Grid System provides users with a quick deploy solution to off-grid power generation and distribution. Specifically, it would be an asset in emergency conditions, such has hurricane storm or earthquake relief.

Primary unit 900, as illustrated in FIGS. 7A-7B, is formed in this construction from a lower polymeric molded piece 902 and an upper polymeric molded piece 912. Other constructions utilize fiberglass or other water-resistant material instead of a polymeric material. Lower piece 902 has a bottom section 903, sidewalls 904 and a vertical wall 905. Lower piece 902 may be considered as the “hull” of platform 900. Upper piece 912 has an overhang 914 into which vertical wall 905 is insertable; the inner surface of overhang 914 and the outer surface of wall 905 preferably are bonded together to form a water-tight barrier and one or more water-tight compartments for storage and/or flotation. Upper piece 912 further includes an upper surface 916 and inner vertical wall 918 and floor 920 to form compartment 922. Upper surface 916 supports a plurality of hinged access hatches 913 having solar panels 915 in this construction. A shackle plate 930 and a shackle reinforcing plate 932 provide a secure attachment for mooring equipment. In this construction, reinforcing plate 932 is “sandwiched” between bottom section 903 and floor 920.

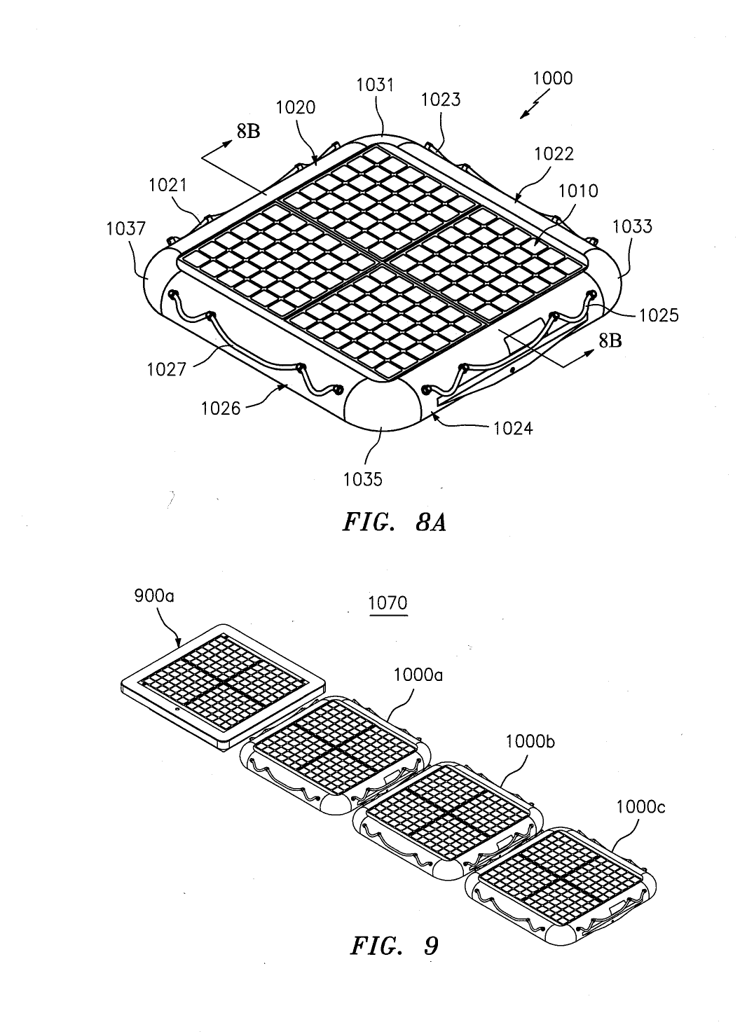

In the construction illustrated in FIGS. 8A-8B for secondary platform unit 1000, four inflatable chambers 1020, 1022, 1024 and 1026 provide flotation. In other constructions, only two or three chambers are utilized. In one construction, the body structure of secondary platform 1000 is made of flexible inflatable water-resistant material such as treated fabric or Hypalon™ chlorosulfonated polyethylene (CSPE) synthetic rubber (CSM) designed to withstand forces of nature and marine environmental conditions, and foldable features such as collapsible side walls of chambers 1020, 1022, 1024 and 1026 and of flexible reinforced corners 1031, 1033, 1035 and 1037 are incorporated into the material of the structure and/or are enabled by the flexible nature of the material. Lines 1021, 1023, 1025 and 1027 enable handling of the unit 1000 individually and for securing assemblage with other units such as shown in FIGS. 9-11. A plurality of solar panels 1010 are deployed on the upper surface of unit 1000; lower surface 1030 is open in some constructions and closed with Hypalon™ CSPE, a treated fabric, and/or other floor material in other constructions.

A shipping assembly 1068 according to the present invention, FIG. 8C, is formed with an inverted primary platform 900 over a plurality of secondary platforms 1000a and 1000b each in a collapsed condition. In this construction, the shipping assembly 1068 is “palletized” and further includes a pallet 1069 to which the platforms 900, 1000a and 1000b are removably strapped during transport. In one construction, each platform is approximately seven feet long by seven feet wide. This invention may also be expressed as a method of selecting at least one primary platform and selecting at least one secondary platform having at least renewable energy generation capabilities and electrically connectable to the primary platform, the at least one secondary platform having at least one chamber that is inflatable with air to transition from a collapsed condition to an expanded condition. The method further includes placing the primary platform upside down, that is, inverted, on top of the secondary platform while in the collapsed condition to form a shipping assembly, such as shipping assembly 1068. The shipping assembly is then transported to a selected location, and the primary and secondary platforms are deployed at the selected location including inflating the secondary platform to the expanded condition, and electrically connecting together the primary and secondary platforms.

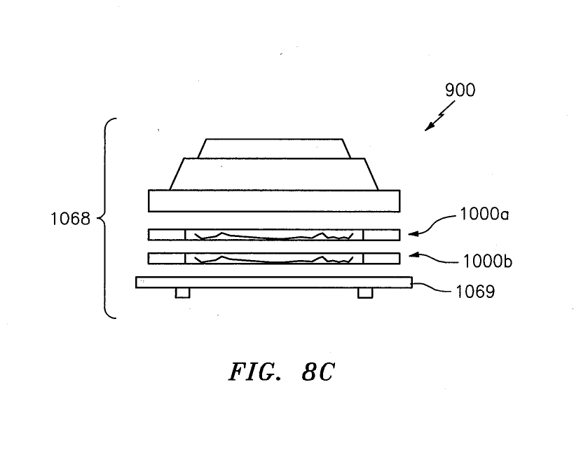

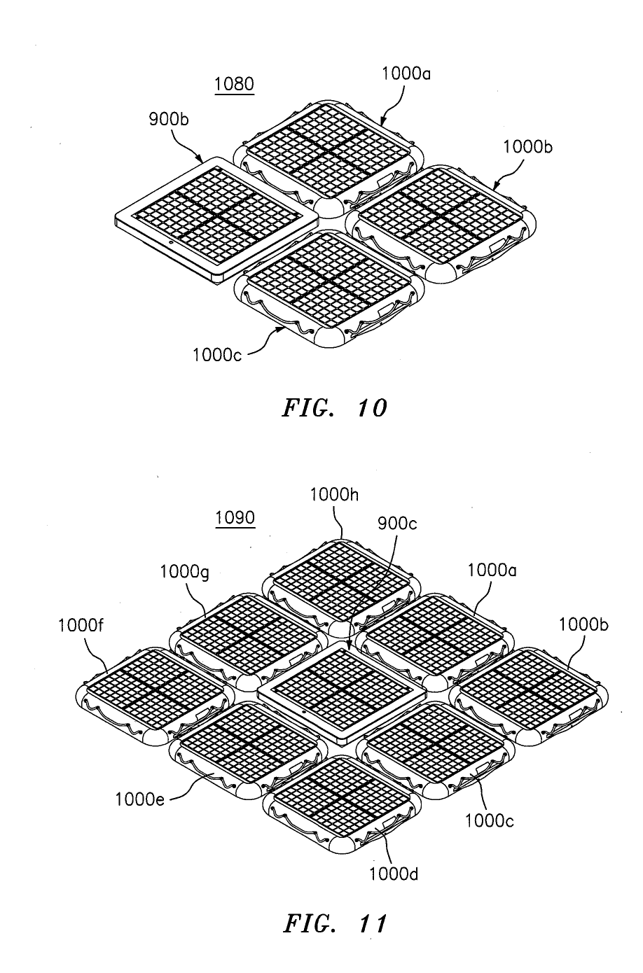

FIG. 9 depicts a linear assembly 1070 of one primary platform 900a linked to three secondary platforms 1000a, 1000b, and 1000c. FIG. 10 shows a square assembly 1080 of one primary platform 900b linked to three secondary platforms 1000a, 1000b, and 1000c. FIG. 11 illustrates a surround assembly 1090 of one primary platform 900c surrounded by eight secondary platforms 1000a, 1000b, 1000c, 1000d, 1000e, 1000f, 1000g and 1000h. Other configurations will occur to those of ordinary skill in the art after reviewing the present disclosure.

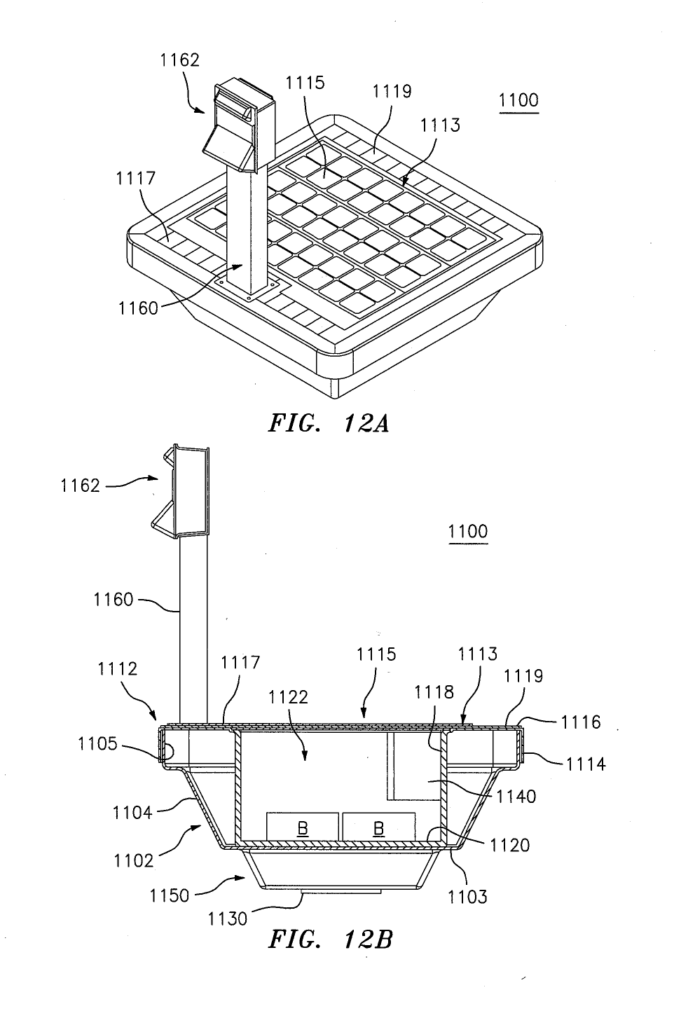

FIGS. 12A-12B depict an alternative molded floating platform 1100 according to the present invention. In this construction, platform 1100 is formed of an upper polymeric molded piece piece 1102 and an upper polymeric molded piece 1112. Other constructions utilize fiberglass or other water-resistant material instead of a polymeric material. Lower piece 1102 has a bottom section 1103 with an additional lower section 1150 for added buoyancy and/or storage space, sidewalls 1104 and a vertical wall 1105. Lower piece 1102 may be considered as the “hull” of platform 1100. Upper piece 1112 has an overhang 1114 into which vertical wall 1105 is insertable; the inner surface of overhang 1114 and the outer surface of wall 1105 preferably are bonded together to form a water-tight barrier and one or more water-tight compartments for storage and/or flotation, Upper piece 1112 further includes an upper surface 1116 and inner vertical wall 1118 and floor 1120 to form compartment 1122 containing batteries B and inverter 1140, such as a Phoenix inverter model 48-3000. An IOT (internet of things) communication system is included in some constructions. Upper surface 916 supports at least one access hatch 1113 having solar panels 1115 in this construction such as SP52A or ISP42Q walkable panels. Permateek panels 1117 and 1119 provide an attractive support surface. Preferably, solar panels 1115 and Permateek panels 1117, 1119 will support the weight of at least one human when suitable structural support is provided beneath each panel, such as a recessed frame within access hatch 1113 so that the panels are flush with the upper surface of the hatch structure. A HyPower pedestal 1160 has power connections and gauges 1162 to enable recharging of vessels and other vehicles and/or equipment; in other constructions, a different user interface such as a Merco Marine UP-1 utility post can be utilized, and/or a telecommunications antenna can be included.

A shackle plate 1130, FIG. 12B, typically is made of marine grade metal to serve as a secure attachment point for mooring equipment. Plate 1130 can also be configured to add ballast weight to platform 1100.

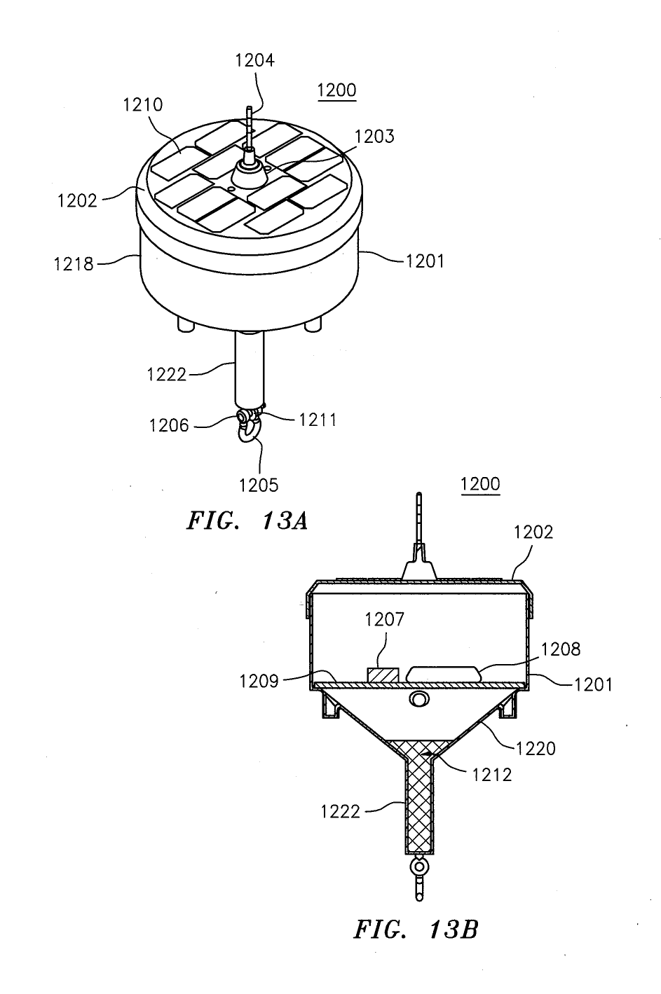

FIGS. 13A-13B show an alternative floating buoy-type platform 1200 according to the present invention having a body 1201 which supports a cap 1202 at an upper region 1218 and has a tapered region 1220 terminating in a lower, region 1222. In this construction, platform 1200 includes antenna mount 1203, antenna 1204, bow lifting shackle body 1205 and bow lifting shackle pin 1206, a solar panel inverter 1207 such as a Genasun inverter, an IOT Sensor/Communication Computer 1208 such as a BluCloud IOT system, and an electronics board 1209 which includes a microprocessor and data storage capabilities. Platform 1200 further includes a solar assembly 1210, a shackle component 1211 such as a Model 3032166, and ballast 1212.

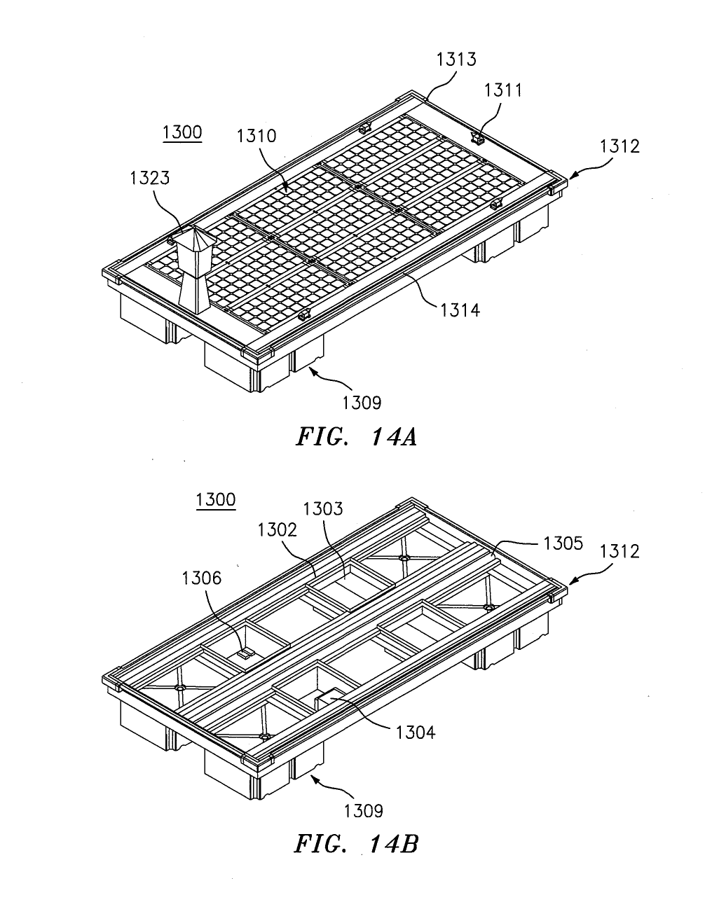

FIGS. 14A-14B illustrate an alternative floating dock-type platform 1300 according to the present invention. This “Micro-Grid Dock” is designed to bring energy production directly into the hard infrastructure of marinas, ports and related aquatic environments. Specifically, the docks collect renewable energy, store that energy and then ultimately redistribute the electric energy back to the user. This can happen directly through a traditional marine power pedestal or through net metering back into the grid. In one construction, the micro-grid docks contain a walkable solar surface, such as available from Solbian of Italy, with batteries (AGM, Lithium or other) and inverter built to be concealed below the deck. The structure of the dock itself can be constructed from wood timber, concrete, metal or composite materials. Overall this “Micro-Grid Dock” will allow electric propulsion and traditional marine vessels to recharge without the need of a larger power grid.

In this construction, platform 1300 includes battery box assembly 1302, power pedestal 1323 which includes an antenna in some constructions, a plurality of batteries 1303, an inverter 1304 such as a Phoenix Inverter 4B-3000 or a Victron Energy Quattro 48/3000, At least one elongated conduit 1305 for passing cables such as a PVC pipe, a solar panel inverter 1306 such as a Genasun inverter, a Blue Sea circuit box 1308, and a plurality of solar panels 1310 such as a SP 130 assembly preferably will support at least one human. A plurality of Cellofoam floats 1309 provide flotation and/or storage. Also included in this construction are a Sun cleat 1310, an elastomeric protective member 1312 such as a Dockusion Korner with end caps 1313. Rubrails 1314 such as DE-40W assist protection from vessels docking at platform 1300. Framing for platform 1300 is provided by marine grade and/or pressure-treated lumber in some constructions and polymeric members such as composites in other constructions.

In general, floating platforms with integrated devices according to the present invention have one or more capabilities as follows:
Integrated Communications and Data Transfer to remote command and control centers;
Integrated Dock Side and Wireless Charging devices and capabilities;
Integration of Vertical Wind Power, Wave Energy, Tidal Power, and/or Thermal Power Generation sources and devices;
Integrated Energy Storage, Battery Charging Management Systems, Power Conversion and Inverters;
Integration of Water Sensing devices;
Integration of Autonomous Navigation system and capabilities;
Integration of Electric Marine Propulsion systems;
Integration of Water Desalination Systems;
Integration of Water Remediation Systems;
Integrated Sustainable Materials; and/or
Integrated Data and Communication for Wireless Signal Services.

Inflatables according to the present invention have one or more capabilities:
Integrated Power Distribution Receptacle Outlet;
Folding features of Inflatable;
Integrated Compressed Air Inflatable Device activated on request;
Integrated PV attachment features to outside surfaces;
Integrated antifouling submerged surface; and/or
Integrated handling features such as Cleats, handles, eyes for lift tackle, etc.

Life Rafts according to the present invention have one or more capabilities: any type of life rafts with integrated flexible solar on roof canopy, energy storage, power distribution marine outlet, and/or extended folding deployable antenna on roof canopy for extended phone communication signal interface.

Floating Solar Energy Platform For Marine Environments: The purpose of this innovation is to generate, store and distribute solar power for marine applications, specifically for electric propulsion battery systems. In some constructions, the structure will be composed of floating docks, solar panels and electric power storage. The configuration of these components will allow marine vessels to dock and inhabit the space while obtaining access to the solar power and supplementary services.

Features include utilizing environmentally friendly materials and construction methods. A priority can be placed on recycled materials. Contains any number of Elements (components) whereby Elements are defined in singularity or plurality quantities as Photovoltaic Component, Energy Storage

System, Energy Storage Charge Controller, Direct Current to Alternating Current Power Inverter, Electrical Outlet, Electrical Interconnecting Cable and Harness, Energy Storage Management System, Energy Distribution System, Water Collection System, Water Storage Tank, Water Filtration System, Water Treatment, Desalination and/or Remediation, Water Distribution System, Water Electrical Pump, LED Light and LED Fixture, vessel docking hardware. Its Photovoltaic, Energy Storage System, Energy Storage Charge Controller, integrated with Photovoltaic Modular Elements, Energy Storage Devices, Energy Storage Charge Controller, DC to AC Power Inverter, Direct Current to Alternating Current Power Inverter, Electrical Outlet, Electrical Interconnecting Cable and Harness, Energy Storage Management System, Energy Distribution System, LED Light and LED Fixture are integrated with each other as a System. Its Water Collection System, Water Storage Tank, Water Filtration System, Water Treatment, Desalination and/or Remediation, Water Distribution System, Water Electrical Pump, Electric Heat Pump are integrated with each other as a System.

Includes an integrated underlayer Flotation System whereby Floating Structure is in contact with water body, where flotation system allows Floating Structure to float above water surface. Flotation Structure is designed and constructed to accommodate docking of any number of vessels, open recreational surface areas, architectural structures, livable sheltered accommodation.

Is secured in place by any number of commercially available mooring system and component, uniquely designed and constructed to Floating Structure requirements. In some constructions, it is designed and constructed to operate in inland ponds, lakes, harbors, marinas, and coastal waters subject to sea state level up to sea state 2 (0.1 to 0.5 metres (3.9 in to 1 ft 7.7 in).

Is designed to provide any number of service usage including Electric Propulsion Vessel Charging, Sailing Regatta Officer Station, Harbor Security Station, Recreational, Aquaculture Farming, Electrical Watercraft Rental and Charging, Hospitality Service, Electrical Power Generation and Distribution, Commercial Fishing.

Floating Solar Energy Platform For AUVs, USVs, ASV,s in Marine Environments: The purpose of this innovation is to generate, store and distribute solar power for marine applications, specifically for electric propulsion operated autonomous underwater vehicles (AUV), unmanned surfaced vehicles (USV), and autonomous surface vehicles (ASV)served by battery energy storage systems. The structure will be composed of floating docks, solar panels and electric power storage and charging systems. The configuration of these components will allow marine vessels to dock and inhabit the space while obtaining access to the solar power, electrical charging of battery, energy storage systems, and supplementary services.

Contains any number of Elements whereby Elements are defined in singularity or plurality quantities as Photovoltaic Component, Energy Storage System, Energy Storage Charge Controller, Direct Current to Alternating Current Power Inverter, Electrical Outlet, Electrical Interconnecting Cable and Harness, Energy Storage Management System, Energy Distribution System, LED Light and LED Fixture, vessel docking hardware, Wireless Electrical Charging components and systems, Wireless Telecommunication components and systems, Remote Camera Monitoring equipment and systems, Border Security Sensing and Information Management System, and Oceanographic Data Test Instrumentation equipment.

Its Elements are integrated with each other singularity or plurality quantities as a System. Includes an integrated under layer Flotation System whereby Floating Structure is in contact with water body, where flotation system allows Floating Structure to float above water surface. Flotation Structure is designed and constructed to accommodate docking and electrical charging of any number of vessels, autonomous underwater vehicles, unmanned surfaced vehicles, autonomous surface vehicles, and architectural structures.

Is secured in place by any number of commercially available mooring system and components (permanently attached and/or dragged based), uniquely designed and constructed to Floating Structure requirements. Systems according to the present invention can provide any number of service usage including Electric Propulsion Vessel Charging and remote data transmission.

Solar Energy Powered Inflatable Raft: The Solar Energy Powered Inflatable Power Raft (SEPIPR) is an inflatable power raft used to generate and distribute renewable energy power in marine applications, emergency situations and disaster relief applications. The SEPIPR unit features: a)—An inflatable flexible material housing on to which a number of flexible photovoltaic solar cells are attached to the material, b)—an external hand rail rope system located at waterline floating level and attached to its exterior housing, c)—an underbody water enclosed ballast housing that has a number of small holes to allow water intrusion into the water ballast housing, d)—a high intensity LED lighting system with electrical intermittent flashing capability, e)—an air compression system that releases compressed air to inflate the SPIPR upon activation of the air compression system, f)—an integrated power port system that allows for interconnecting external water tight shore power cables. In certain constructions, a deployable antenna is provided with transmission and receiving telecommunication signal capabilities.

Inflatable structures according to the present invention are designed to generate and distribute renewable energy. In preferred constructions, such structures are made of flexible inflatable material such as treated fabric designed to withstand forces of nature and marine environmental conditions. In certain constructions, it features an external hand rail rope system attached its exterior housing to allow for external holding an underbody water ballast fully enclosed housing design of flexible material which has a number of small apertures to allow water intrusion into the water ballast housing. Another ballast system that can be utilized includes sponges as disclosed by Terrell et al. in U.S. Patent Publication No. 2015/0344115.

In certain constructions, features any number of flexible photovoltaic solar cells attached to the SEPIPR fabric material. Can feature a photovoltaic power interconnection module with external power interconnection and distribution capabilities. Can feature a high intensity LED lighting system with electrical intermittent flashing capability. Can feature an air compression system that releases compressed air to inflate the SPIPR upon activation of the air compression system. Can feature a power port system that allows for interconnecting external water tight shore power cables and internal electrical power connections. A single SEPIPR unit can be utilized, or a multiple number of interconnected SEPIPR units can be utilized as desired.

In certain constructions, the SEPIPR provides shelter for one or more humans, such as to safeguard occupants during marine emergency situations and disaster relief applications.

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is the intention, therefore, to be limited only as indicated by the scope of the claims appended hereto. Other embodiments will occur to those skilled in the art and are within the following claims.

What is claimed is:

1. A floatable energy platform comprising:
a buoyant structure capable of floating on water;
at least one source of renewable energy carried by the structure, the at least one source of renewable energy including at least one panel of photovoltaic cells that are at least one of (i) flexible or (ii) configured to withstand the weight of at least one human; and
power transfer equipment capable of recharging at least one type of electric-powered vehicle.

2. The platform of claim 1 wherein the structure includes at least one inflatable chamber.

3. The platform of claim 1 further including at least one of: (1) integrated communications equipment capable of data transfer to remote command and control centers; (2) integrated connectors and wireless charging devices; (3) integration of vertical wind power, wave energy, tidal power, and/or thermal power generation sources and devices; (4) integrated energy storage, battery charging management systems, power conversion and inverters; (5) integrated water sensing devices to measure a selected parameter including at least one of temperature, salinity, density and turbidity; (6) integrated autonomous navigation system and capabilities; (7) integrated electric marine propulsion systems; (8) integrated water desalination systems; (9) integrated water remediation systems; (10) integrated sustainable materials; and/or (11) integrated data and communication equipment for wireless signal services.

4. A portable floating energy platform to generate and distribute renewable energy, comprising:
a structure made of flexible material defining at least one inflatable chamber and designed to withstand forces of nature and marine environmental conditions, the structure having an upper surface and a lower surface, with foldable features incorporated into the material of the structure to enable the structure to transition from a collapsed condition to an expanded condition when the structure is inflated with air; and
at least one source of renewable energy.

5. The portable platform of claim 4 further including at least one of:
(a) integrated power distribution receptacle outlet; (b) integrated compressed air inflatable device capable of being activated on request; (c) integrated photovoltaic attachment features to outside surfaces; (d) integrated antifouling submerged surface; and/or (e) integrated handling features including at least one of cleats, handles, and eyes for lift tackle.

6. The portable platform of claim 5 further including an external hand rail rope system attached to the exterior housing to allow for external holding.

7. The portable platform of claim 6 further including at least one of: (i) energy storage; (ii) power distribution marine outlet; and/or (iii) antenna for extended telecommunication signal interface.

8. An assembly comprising:
at least one primary floatable platform having at least energy storage capabilities; and
at least one secondary floatable platform having at least renewable energy generation capabilities and electrically connected to the primary platform, the at least one secondary platform defining at least one chamber that is inflatable with air to transition from a collapsed condition to an expanded condition.

9. The assembly of claim 8 wherein the primary platform is formed from at least two rigid pieces that establish at least one storage compartment for energy storage devices

10. The assembly of claim 9 wherein each of at least two secondary platforms are directly connected electrically to the primary platform.

11. The assembly of claim 9 further including at least two secondary platforms and a pallet to which the primary and secondary platforms are removably strapped during transport.

12. A method of transporting and deploying floatable modular microgrid platforms, comprising:
selecting at least one primary floatable platform having at least energy storage capabilities;
selecting at least one secondary floatable platform having at least renewable energy generation capabilities and electrically connectable to the primary platform, the at least one secondary platform defining at least one chamber that is inflatable with air to transition from a collapsed condition to an expanded condition;
placing the primary platform upside down on top of the secondary platform while in the collapsed condition to form a shipping assembly;
transporting the shipping assembly to a selected location; and
deploying the primary and secondary platforms at the selected location including inflating the secondary platform to the expanded condition, and electrically connecting together the primary and secondary platforms.

13. The method of claim 12 further including at least two secondary platforms and a pallet to which the primary and secondary platforms are removably strapped during transport.
